(19) United States
(12) Patent Application Publication
(10) Pub. No.: US 2024/0309648 A1
(43) Pub. Date: Sep. 19, 2024

(54) Adhesive Floor/Wallboard and Method of Using Same

(71) Applicant: Wellmade Floor Coverings International, Inc., Wilsonville, OR (US)

(72) Inventor: Zhu Chen, Nanjing (CN)

(21) Appl. No.: 18/672,457

(22) Filed: May 23, 2024

Related U.S. Application Data
(62) Division of application No. 17/000,860, filed on Aug. 24, 2020, now Pat. No. 11,993,937.

(51) Int. Cl. E04F 13/08; B32B 3/26; B32B 5/18; B32B 7/06; B32B 7/12; E04F 15/02; E04F 15/10

(52) U.S. Cl. CPC E04F 13/0887; B32B 3/266; B32B 5/18; B32B 7/06; B32B 7/12; E04F 13/0866; E04F 15/02155; E04F 15/107; B32B 2471/00; B32B 2607/00

(57) ABSTRACT

An adhesive floor/wallboard includes a floor/wallboard main body layer and a buffer layer adhered to the back surface of the floor/wallboard main body layer. The buffer layer is provided with a plurality of holes. The holes extend through the buffer layer to the main body layer. Glue is deposited in the holes. The buffer layer is adhered to the back surface of the floor/wallboard. The glue in the holes makes direct contact with the floor/wallboard main body at the holes. Due to the holes and their depth, the contact area between the glue, the buffer layer and the main body is increased. Accordingly, the adhesive floor/wallboard can be more firmly adhered to a backing surface.

### CROSS REFERENCE TO RELATED APPLICATION

The present application is a Division of U.S. patent application Ser. No. 17/000,860, filed Aug. 24, 2020, entitled “Adhesive Floor/Wallboard and Method of Using Same”, the contents of which are incorporated herein by reference in its entirety.

### TECHNICAL FIELD

The disclosure relates to a floor/wallboard, and in particular, to a floor/wallboard that is adhered and mounted to a backing surface, which may be a floor or wall.

### RELATED ART

The relatively thin floors or wallboards with a thickness of 0.5-5 mm are widely applied to places such as shopping malls and office places due to low costs. The floors or wallboards of such a thickness cannot be provided with lock catches on the sides or edges, so the floors or wallboards are usually pressed into place and secured with an adhesive. The floors and wallboards may have a problem of poor sound insulation and poor adherence. The solution described herein is to apply a relatively soft buffer material, such as cork wood, foamed EVA, or IXPE, to the back surface of the floor or wallboard to form a buffer layer. During mounting, the buffer layer is adhered to a backing surface by glue. Holes in the buffer layer allow the glue to form a bond with a main body of the floor or wallboard, the buffer layer, and the backing surface. As a result, the floor or wallboard may be adhered firmly to the backing surface.

### SUMMARY

An object of the disclosure is to provide an adhesive floor/wallboard, which can be more firmly adhered to a backing or base surface. As described below, the exemplary adhesive floor/wallboard structurally includes a floor/wallboard main body layer, and further includes a buffer layer adhered to the back surface of the floor/wallboard main body layer. The buffer layer is provided with a plurality of holes. The holes have a depth that extends through the buffer layer so the holes extend to and communicate with the main body layer.

The holes may be round holes, elliptical holes, square holes or irregular holes, and the area of the holes may be 25% to 75% of the area of the buffer layer. The holes may be made in the form of patterns, logos, and characters to improve the identification of the adhesive floor/wallboard.

Preferably, the material of the buffer layer is foamed PVC, cork wood, foamed EVA, or IXPE (crosslinked polyethylene foaming material).

The adhesive floor/wallboard may also include a self-adhesive layer and a release layer, where the self-adhesive layer is adhered to the back surface of the buffer layer, the release layer is adhered to the back surface of the self-adhesive layer, and the self-adhesive layer and the release layer are also provided with holes in the positions corresponding to the holes of the buffer layer.

Preferably, the thickness of the floor/wallboard main body layer is 0.5-5 mm and the thickness of the buffer layer is 0.5-5 mm.

Preferably, the material of the floor/wallboard main body layer is a wood board, a bamboo board, a high density PVC composite material, a glass magnesium plate, a high density fiberboard, a medium density fiberboard, an aluminum alloy material, a cement board, an aluminum-plastic board, textile, a paperboard or an HPL fireproof board (thermosetting resin impregnated paper high pressure laminate board).

In another aspect of the disclosure, the buffer layer is pasted to the back surface of the thin floor/wallboard, and a plurality of holes is formed on the buffer layer.

During mounting of the adhesive floor/wallboard to a backing surface, the glue is applied to the buffer layer or the release paper, depending upon the embodiment of the adhesive floor/wallboard. The glue can make direct contact with the main body of the floor/wallboard through the holes. Due to the holes, the contact area between the glue and the buffer layer can be increased, so that the adhesive floor/wallboard and the backing surface to which the adhesive floor/wallboard is adhered may be more firmly adhered. The buffer layer can play roles of balancing, buffering, and silencing for the floor, and can play roles of balancing, buffering, and sound insulation for the wallboard.

The self-adhesive layer and the release layer may be disposed on the back surface of the buffer layer, and the holes of the self-adhesive layer and release layer may be provided in the positions corresponding to the holes of the buffer layer. Due to the self-adhesive layer, the adhesive floor/wallboard may be fixed on the backing surface to prevent displacement when the glue is not dried yet. Especially when used as a wallboard and when the glue is not cured yet, the adhesive floor/wallboard may be prone to slip off of the wall if the self-adhesive layer is not used for fixing the position in advance. According to the disclosure, the wallboard is fixed with the self-adhesives, and then as the glue cures, the floor/wallboard is firmly adhered in place to the backing surface.

### BRIEF DESCRIPTION OF THE DRAWINGS

The disclosure will be further described below with reference to the accompanying drawings and embodiments.

FIG. 1 is a cross-sectional view of an adhesive floor/wallboard according to Embodiment 1.

FIG. 2 is a schematic structural diagram of a back surface of an adhesive floor/wallboard according to Embodiment 1.

FIG. 3 is a schematic structural diagram of a back surface of an adhesive floor/wallboard according to Embodiment 2.

FIG. 4 is a schematic structural diagram of a back surface of an adhesive floor/wallboard according to Embodiment 3.

FIG. 5 is a cross-sectional view of an adhesive floor/wallboard according to Embodiment 5.

### DETAILED DESCRIPTION

### Embodiment 1

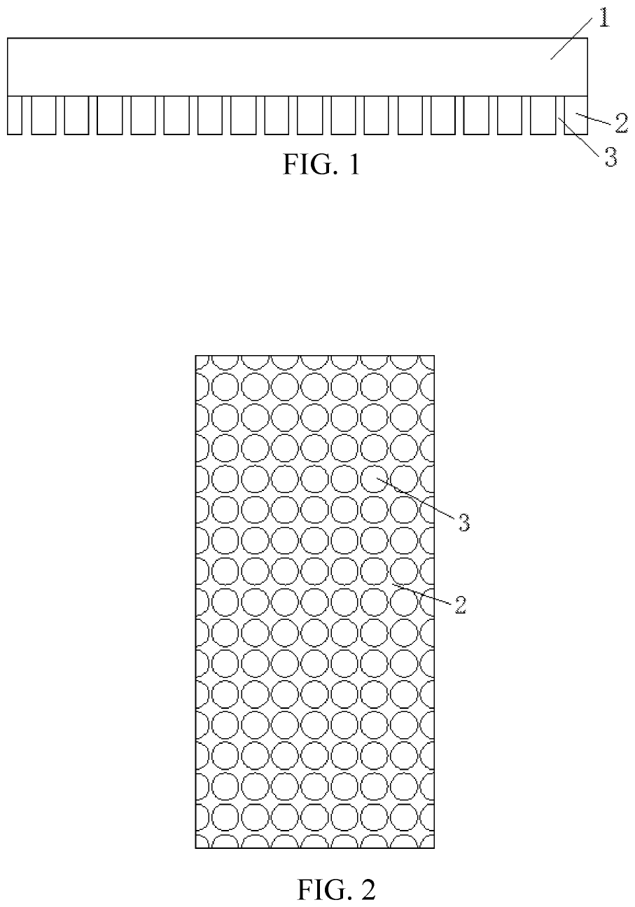

As shown in FIG. 1 and FIG. 2, the adhesive floor/wallboard structurally includes a floor/wallboard main body layer 1 and further includes a buffer layer 2 adhered to the back surface of the floor/wallboard main body layer. The buffer layer is provided with a plurality of holes 3. The holes at the back surface of the floor/wallboard main body layer 1 extend through and communicate with the outside edges of the adhesive floor/wallboard. The holes 3 extend through the buffer layer 2 and extend to and communicate with the main body layer 1. The thickness of the floor/wallboard main body layer is 0.5 mm, the thickness of the buffer layer is 0.5 mm, the diameter of the holes is 1 mm, the holes are round holes, the area of the holes is 50% of the area of the buffer layer, and the material of the buffer layer is foamed PVC. The material of the floor/wallboard main body layer is a cement board.

During preparation, foamed PVC is adhered to the back surface of the floor/wallboard main body layer, the buffer layer formed by the foamed PVC is punched and the depth of the holes is controlled to avoid damage to the floor/wallboard main body layer. Alternatively, the buffer layer may be foamed PVC, punched in advance, and then adhered to the back surface of the floor/wallboard main body layer. Or the hole structures are formed on the buffer layer formed by the foamed PVC through punching, etching, molding, casting or any other manner.

During use, after the backing surface on the floor or the wall is cleaned, glue is applied to the buffer layer. The amount of glue applied is sufficient to enter the holes such that when the adhesive floor/wallboard is pressed into place onto the backing surface, the glue enters the holes and contacts the main body of the adhesive floor/wallboard. Then, pressure is applied to the floor/wallboard to cause the glue to enter the holes, and the installation work is completed after the glue is cured.

### Embodiment 2

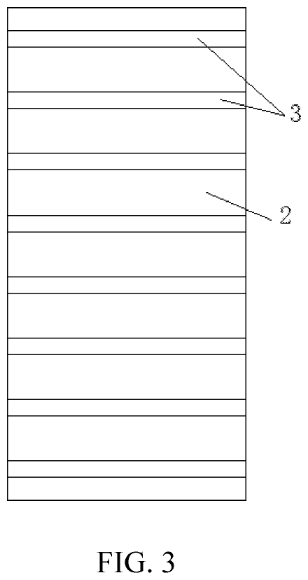

As shown in FIG. 3, the adhesive floor/wallboard structurally includes a floor/wallboard main body layer 1 and further includes a buffer layer 2 adhered to the back surface of the floor/wallboard main body layer. The buffer layer is provided with a plurality of holes 3. The holes have a depth that extends through the buffer layer so the holes communicates with the main body layer. The thickness of the floor/wallboard main body layer is 2 mm, the thickness of the buffer layer is 1 mm, the holes are rectangular shaped holes, the area of the holes is 35% of the area of the buffer layer, and the material of the buffer layer is cork wood. The material of the floor/wallboard main body layer is an aluminum alloy material.

During preparation of the buffer layer of adhesive floor/wallboard, cork wood is adhered to the back surface of the floor/wallboard main body layer, and then is cut to form rectangular holes, avoiding damage to the floor/wallboard main body layer during cutting. Alternatively, during preparation of the buffer layer of adhesive floor/wallboard, cork wood is cut into bars in advance, and then the bars adhered to the back surface of the floor/wallboard main body layer with some voids between the bar-shaped cork wood pieces to form the bar rectangular shaped holes on the buffer layer. Alternatively, the hole structures are formed on the buffer layer formed by foamed PVC through punching, etching, molding, casting or any other manner.

During use, after the backing surface on the floor or the wall is cleaned, glue is applied to the buffer layer. The amount of glue applied is sufficient to enter the holes such that when the adhesive floor/wallboard is pressed into place onto the backing surface, the glue enters the holes and contacts the main body of the adhesive floor/wallboard. Then, pressure is applied to the floor/wallboard to cause the glue to enter the holes, and the installation work is completed after the glue is cured.

### Embodiment 3

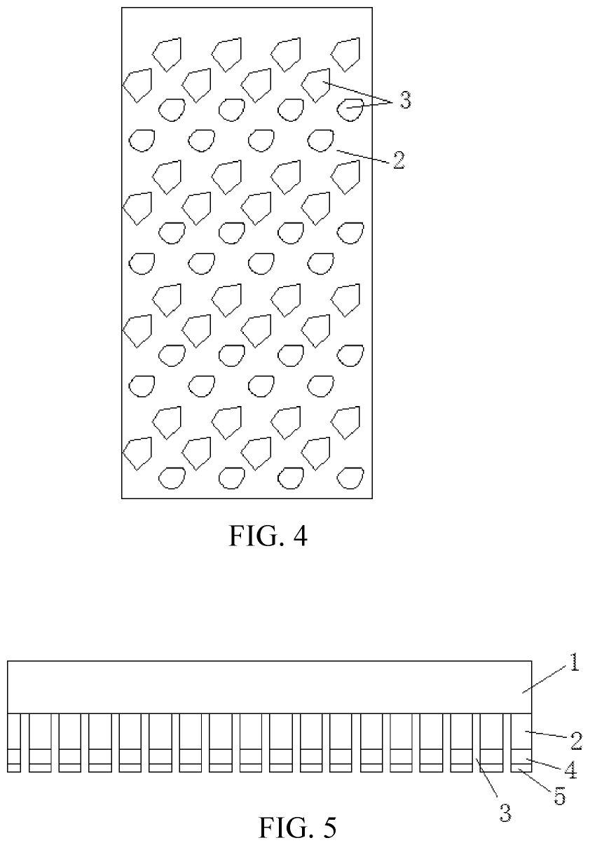

As shown in FIG. 4, the adhesive floor/wallboard structurally includes a floor/wallboard main body layer 1 and further includes a buffer layer 2 adhered to the back surface of the floor/wallboard main body layer. The buffer layer is provided with a plurality of holes 3. The holes have a depth that extends through the buffer layer so the holes communicates with the main body layer. The thickness of the floor/wallboard main body layer is 5 mm, the thickness of the buffer layer is 3 mm, the holes are irregular holes, the area of the holes is 25% of the area of the buffer layer, and the material of the buffer layer is foamed EVA. The material of the floor/wallboard main body layer is a medium density fiberboard.

During use, after the backing surface on the floor or the wall is cleaned, glue is applied to the buffer layer. The amount of glue applied is sufficient to enter the holes such that when the adhesive floor/wallboard is pressed into place onto the backing surface, the glue enters the holes and contacts the main body of the adhesive floor/wallboard. Then, pressure is applied to the floor/wallboard to cause the glue to enter the holes, and the installation work is completed after the glue is cured.

### Embodiment 4

The adhesive floor/wallboard structurally includes a floor/wallboard main body layer 1 and further includes a buffer layer 2 adhered to the back surface of the floor/wallboard main body layer. The buffer layer is provided with a plurality of holes 3. The holes have a depth that extends through the buffer layer so the holes communicates with the main body layer. The thickness of the floor/wallboard main body layer is 3 mm, the thickness of the buffer layer is 5 mm, the holes are elliptical holes, the area of the holes is 40% of the area of the buffer layer, and the material of the buffer layer is IXPE. The material of the floor/wallboard main body layer is a high density fiberboard.

During use, after the backing surface on the floor or the wall is cleaned, glue is applied to the buffer layer. The amount of glue applied is sufficient to enter the holes such that when the adhesive floor/wallboard is pressed into place onto the backing surface, the glue enters the holes and contacts the main body of the adhesive floor/wallboard. Then, pressure is applied to the floor/wallboard to cause the glue to enter the holes, and the installation work is completed after the glue is cured.

### Embodiment 5

As shown in FIG. 5, the adhesive floor/wallboard structurally includes a floor/wallboard main body layer 1 and further includes a buffer layer 2 adhered to the back surface of the floor/wallboard main body layer. The buffer layer is provided with a plurality of holes 3. The holes have a depth that extends through the buffer layer so the holes communicate with the main body layer. The adhesive floor/wallboard further includes a self-adhesive layer 4 and a release layer 5, the self-adhesive layer is adhered to the back surface of the buffer layer, the release layer is adhered to the back surface of the self-adhesive layer, and the adhesive layer and the release layer are also provided with holes in the positions corresponding to the holes of the buffer layer. The thickness of the floor/wallboard main body layer is 5 mm, the thickness of the buffer layer is 4 mm, the holes are round holes, the area of the holes is 45% of the area of the buffer layer, and the material of the buffer layer is cork wood. The material of the floor/wallboard main body layer is a glass magnesium board.

During use, after the backing surface on the floor or wall is cleaned, glue is applied over the release layer and into the holes. The amount of glue applied is sufficient to enter the holes such that when the adhesive floor/wallboard is pressed into place onto the backing surface, the glue enters the holes and contacts the main body of the adhesive floor/wallboard. Then, the release layer of the adhesive floor/wallboard is removed. The adhesive floor/wallboard is pressed into place onto a backing surface. The self-adhesive holds the adhesive floor/wallboard in place. Pressure is applied to the floor/wallboard causing the glue to enter the holes, and the installation work is completed after the glue is cured. The self-adhesive layer is used for fixing the position in advance before the glue is cured, so as to prevent the floor/wallboard from being displaced or peeled off the backing surface.

### Embodiment 6

The adhesive floor/wallboard structurally includes a floor/wallboard main body layer and further includes a buffer layer adhered to the back surface of the floor/wallboard main body layer. The buffer layer is provided with a plurality of holes. The adhesive floor/wallboard further includes a self-adhesive layer and a release layer, the self-adhesive layer is adhered to the back surface of the buffer layer, the release layer is adhered to the back surface of the self-adhesive layer, and the adhesive layer and the release layer are also provided with holes in the positions corresponding to the holes of the buffer layer. The thickness of the floor/wallboard main body layer is 0.5 mm, the thickness of the buffer layer is 3 mm, the holes are square holes, the area of the holes is 50% of the area of the buffer layer, and the material of the buffer layer is foamed EVA. The material of the floor/wallboard main body layer is a high density PVC composite material.

During use, after the backing surface on the floor or wall is cleaned, glue is applied over the release layer and into the holes. The amount of glue applied is sufficient to enter the holes such that when the adhesive floor/wallboard is pressed into place onto the backing surface, the glue enters the holes and contacts the main body of the adhesive floor/wallboard. Then, the release layer of the adhesive floor/wallboard is removed. The adhesive floor/wallboard is pressed into place onto a backing surface. The self-adhesive holds the adhesive floor/wallboard in place. Pressure applied to the floor/wallboard causes the glue to enter the holes, and the installation work is completed after the glue is cured. The self-adhesive layer is used for fixing the position in advance before the glue is cured, so as to prevent the floor/wallboard from being displaced or peeled off the backing surface.

### Embodiment 7

The adhesive floor/wallboard structurally includes a floor/wallboard main body layer and further includes a buffer layer adhered to the back surface of the floor/wallboard main body layer. The buffer layer is provided with a plurality of holes. The adhesive floor/wallboard further includes a self-adhesive layer and a release layer, the self-adhesive layer is adhered to the back surface of the buffer layer, the release layer is adhered to the back surface of the self-adhesive layer, and the adhesive layer and the release layer are also provided with holes in the positions corresponding to the holes of the buffer layer. The thickness of the floor/wallboard main body layer is 2.5 mm, the thickness of the buffer layer is 0.5 mm, the holes are round holes, the area of the holes is 60% of the area of the buffer layer, and the material of the buffer layer is IXPE. The material of the floor/wallboard main body layer is a bamboo board.

During use, after the backing surface on the floor or wall is cleaned, glue is applied over the release layer and into the holes. The amount of glue applied is sufficient to enter the holes such that when the adhesive floor/wallboard is pressed into place onto the backing surface, the glue enters the holes and contacts the main body of the adhesive floor/wallboard. Then, the release layer of the adhesive floor/wallboard is removed. The adhesive floor/wallboard is pressed into place onto a backing surface. The self-adhesive holds the adhesive floor/wallboard in place. Pressure is applied to the floor/wallboard and causes the glue to enter the holes, and the installation work is completed after the glue is cured. The self-adhesive layer is used for fixing the position in advance before the glue is cured, so as to prevent the floor/wallboard from being displaced or peeled off the backing surface.

### Embodiment 8

The adhesive floor/wallboard structurally includes a floor/wallboard main body layer and further includes a buffer layer adhered to the back surface of the floor/wallboard main body layer. The buffer layer is provided with a plurality of holes. The adhesive floor/wallboard further includes a self-adhesive layer and a release layer, the self-adhesive layer is adhered to the back surface of the buffer layer, the release layer is adhered to the back surface of the self-adhesive layer, and the adhesive layer and the release layer are also provided with holes in the positions corresponding to the holes of the buffer layer. The thickness of the floor/wallboard main body layer is 4 mm, the thickness of the buffer layer is 2 mm, the holes are rectangular holes, the area of the holes is 75% of the area of the buffer layer, and the material of the buffer layer is foamed PVC. The material of the floor/wallboard main body layer is a wood board.

During use, after the backing surface on the floor or wall is cleaned, glue is applied over the release layer and into the holes. The amount of glue applied is sufficient to enter the holes such that when the adhesive floor/wallboard is pressed into place onto the backing surface, the glue enters the holes and contacts the main body of the adhesive floor/wallboard. Then, the release layer of the adhesive floor/wallboard is removed. The adhesive floor/wallboard is pressed into place onto a backing surface. The self-adhesive holds the adhesive floor/wallboard in place. Pressure is applied to the floor/wallboard causes the glue to enter the holes, and the installation work is completed after the glue is cured. The self-adhesive layer is used for fixing the position in advance before the glue is cured, so as to prevent the floor/wallboard from being displaced or peeled off the backing surface.

### Embodiment 9

The present embodiment is basically the same as Embodiment 8, and the difference is that the material of the floor/wallboard main body layer is an aluminum-plastic board.

### Embodiment 10

The present embodiment is basically the same as Embodiment 8, and the difference is that the material of the floor/wallboard main body layer is textile.

### Embodiment 11

The present embodiment is basically the same as Embodiment 8, and the difference is that the material of the floor/wallboard main body layer is a paperboard.

### Embodiment 12

The present embodiment is basically the same as Embodiment 8, and the difference is that the material of the floor/wallboard main body layer is an HPL fireproof board.

The above embodiments are preferred implementations of the disclosure, but the implementations of the disclosure are not limited by the above embodiments, and any changes, modifications, substitutions, combinations and simplifications made without departing from the spirit and principles of the disclosure should be equivalent replacements and are all included in the protection scope of the disclosure.

In the description of the disclosure, it is to be understood that the terms indicating the orientation or the positional relationship are based on the orientation or positional relationship shown in the drawings, are merely for the convenience of describing the disclosure and simplifying the description rather than indicating or implying that the structure indicated must have a specific orientation and be constructed in a specific orientation, and thus are not to be construed as limiting the disclosure.

In the description of the disclosure, it should be noted that the orientation or positional relationship indicated by the terms “center”, “upper”, “lower”, “left”, “right”, “vertical”, “horizontal”, “inside” and “outside” are based on the orientation or positional relationship shown in the drawings, or the orientation or positional relationship that the product according to the disclosure is conventionally placed when in use, are merely for the convenience of describing the disclosure and simplifying the description rather than indicating or implying that the device or element indicated must have a specific orientation and be constructed and operated in a specific orientation, and thus are not to be construed as limiting the disclosure.

Moreover, the terms “horizontal”, “vertical”, “overhanging”, and the like do not mean that the component is required to be absolutely horizontal or overhanging, but may be slightly inclined. For example, the “horizontal” simply means that the direction thereof is more horizontal than “vertical”, and does not mean that the structure must be completely horizontal, but may be slightly inclined.

In the disclosure, unless explicitly stated and defined otherwise, the condition that the first feature is on or under the second feature may include that the first feature and the second feature are in direct contact, and may also include that the first feature and the second feature are not in direct contact and are in contact by additional features therebetween. Besides, the condition that the first feature is over, above and on the second feature includes that the first feature is directly above and obliquely above the second feature, or merely indicates that the level of the first feature is higher than the second feature. The condition that the first feature is under, below and underneath the second feature includes that the first feature is directly below and obliquely below the second feature, or merely indicates that the level of the first feature is lower than the second feature.

What is claimed is:

1. A method comprising:
accessing an adhesive floor/wallboard that has a floor/wallboard main body layer, and a buffer layer adhered to the back surface of the floor/wallboard main body layer, wherein the buffer layer is provided with a plurality of holes;
applying an adhesive to the buffer layer in a manner such that the adhesive at least partially covers the buffer layer and enters the holes sufficiently so as to make contact with the main body layer through the holes when the adhesive floor/wallboard is pressed into place on a backing surface; and
pressing the adhesive floor/wallboard into place onto the backing surface.

2. The method of claim 1, wherein the step of pressing the adhesive floor/wallboard into place includes a backing surface comprising a wall.

3. The method of claim 1, wherein the step of pressing the adhesive floor/wallboard into place includes a backing surface comprising a floor.

4. A method comprising:
accessing an adhesive floor/wallboard that has a floor/wallboard main body layer, and a buffer layer adhered to the back surface of the floor/wallboard main body layer, wherein the buffer layer is provided with a plurality of holes and the adhesive floor/wallboard further comprises a self-adhesive layer and a release paper layer, wherein the self-adhesive layer is adhered to the back surface of the buffer layer, the release paper layer is adhered to the back surface of the self-adhesive layer, and the self-adhesive layer and the release paper layer are also provided with holes in the positions corresponding to the holes of the buffer layer;
applying an adhesive to the release layer in a manner such that the adhesive at least partially covers the release layer and enters the holes sufficiently so as to make contact with the main body layer through the holes when the adhesive floor/wallboard is pressed into place on a backing surface;
removing the release layer to expose the self-adhesive layer; and
pressing the adhesive floor/wallboard into place on a backing surface.

5. The method of claim 4, wherein the step of pressing the adhesive floor/wallboard into place includes a backing surface comprising a wall.

6. The method of claim 4, wherein the step of pressing the adhesive floor/wallboard into place includes a backing surface comprising a floor.
